(19) United States
(12) Patent Application Publication
(10) Pub. No.: US 2014/0302200 A1
(43) Pub. Date: Oct. 9, 2014

(54) NUTRITIONAL COMPOSITIONS HAVING SOLID PARTICLES AND METHODS FOR MAKING AND USING SAME

(71) Applicants: Marie-Louise Mateus, Le Mont-sur-Lausanne (CH); Yves Michael Tthonney, Verbier (CH)

(72) Inventors: Marie-Louise Mateus, Le Mont-sur-Lausanne (CH); Yves Michael Tthonney, Verbier (CH)

(73) Assignee: NESTEC S.A., Vevey (CH)

(21) Appl. No.: 14/111,806

(22) PCT Filed: Apr. 19, 2012
(86) PCT No.: PCT/EP12/57207

§ 371 Date: Jun. 23, 2014

Related U.S. Application Data
(60) Provisional application No. 61/478,050, filed on Apr. 21, 2011.

(51) Int. Cl. A23L 1/00

(52) U.S. Cl. CPC A23L 1/005
USPC 426/72; 426/96; 426/93; 426/289; 426/295

(57) ABSTRACT

A packaged food product comprising a package housing and a nutritional composition having reduced stickiness on its surface, comprising a plurality of solid particles on at least one surface of the nutritional composition and a carbohydrate, wherein the solid particles have a diameter between about 1 mm and about 10 mm, and wherein the at least one surface of the nutritional composition is an external surface.

### BACKGROUND

The present disclosure relates generally to health and nutrition. More specifically, the present disclosure relates to nutritional compositions having solid particles on at least one surface and methods for making and using same.

There are many types of nutritional compositions currently on the market. Nutritional compositions can be targeted toward certain consumer types, for example, young, elderly, athletic, etc., based on the specific ingredients of the nutritional composition. For example, it is well established that carbohydrate ingestion during or before exercise improves endurance performance, as well as shorter duration exercise. One manner in which to provide the proper amounts of carbohydrates required for endurance performance is in the form of a solid performance bar having a specific carbohydrate composition. Known performance bars, however, may be difficult to consume during exercise, may be too dense or heavy for consumption before or during exercise, or may have a chalky or bland taste. Such performance bars may also be difficult to consume because many performance bars are rather sticky on exterior surfaces; in many cases, the main reason being the type of carbohydrate (high amounts of sugars). As a result, the bars may undesirably stick to the wrapper in which is it packaged, or may be sticky in the hands of the consumer. Such characteristics make consumption of the bar difficult and/or messy for the consumer and, therefore, less enticing.

One goal of nutritional support, therefore, is to provide nutritional compositions that can very efficiently provide individuals with carbohydrates, while at the same time providing an aesthetically and physically well-received product.

### SUMMARY

The nutritional compositions of the present disclosure provide carbohydrates in an amount to provide proper fuel for performance. The nutritional compositions also include a coating of solid particles on an exterior of the composition to enhance the aesthetics of, and to reduce the stickiness of, the solid nutritional compositions. The nutritional compositions may include a carbohydrate fraction having glucose. The nutritional compositions may include a carbohydrate fraction having glucose and fructose in a ratio from about 3:1 to about 1:1. The performance may be, for example, athletic, academic, or other performances requiring physical stamina and/or mental alertness.

In an embodiment, nutritional compositions having a plurality of solid particles on at least one surface of the nutritional composition and a carbohydrate fraction are provided.

In an embodiment, nutritional compositions having a plurality of solid particles on at least one surface of the nutritional composition and a carbohydrate fraction including glucose are provided.

In an embodiment, nutritional compositions having a plurality of solid particles on at least one surface of the nutritional composition and a carbohydrate fraction including glucose and fructose in a ratio from about 3:1 to about 1:1 are provided.

In another embodiment, packaged food products including a package housing a nutritional composition having a plurality of solid particles on at least one surface of the nutritional composition and a carbohydrate fraction.

In another embodiment, packaged food products including a package housing a nutritional composition having a plurality of solid particles on at least one surface of the nutritional composition and a carbohydrate fraction including glucose.

In another embodiment, packaged food products including a package housing a nutritional composition having a plurality of solid particles on at least one surface of the nutritional composition and a carbohydrate fraction including glucose and fructose in a ratio from about 3:1 to about 1:1.

In an embodiment, the package is manufactured from a material selected from the group consisting of paperboard, cardboard, plastic, metal, foil or combinations thereof. In an embodiment, the package is a foil wrapper.

In an embodiment, the solid particles are selected from a group consisting of rolled oats, grains, cookie particles, crisp discs, or any combinations thereof. In an embodiment, the solid particles are crisp discs. In an embodiment, the solid particles are rolled oats.

In an embodiment, the solid particles are substantially flat. The solid particles may have a shape selected from the group consisting of oval, circular, triangular, square, rectangular, pentagonal, hexagonal, heptagonal, octagonal, or combinations thereof. The solid particles may have a rough surface to help the solid particles adhere to the nutritional composition.

In an embodiment, the solid particles are substantially circular. The solid particles have a diameter between about 1 mm and about 10 mm. The solid particles have a diameter between about 2 mm and about 6 mm. The solid particles have a diameter between about 4 mm and about 6 mm. The solid particles have a diameter of about 4 mm.

The solid particles may be artificially or naturally colored. In an embodiment, the solid particles on the nutritional compositions may be at least two different colors. In another embodiment, the solid particles on the nutritional compositions may be substantially the same color.

In an embodiment, the solid particles have a high sugar content and low amounts of fats and proteins.

In an embodiment, the solid particles have a high protein and a high sugar content.

In an embodiment, the solid particles have a high sugar, high protein and high fat content.

In an embodiment, the at least one surface of the nutritional composition is an external surface. The at least one surface of the nutritional composition may be selected from the group consisting of, a top surface, a bottom surface, a side surface, an end surface, or combinations thereof.

In an embodiment, the carbohydrate fraction is at least 30% glucose and fructose. The carbohydrate fraction may also be about 50% glucose and fructose. The carbohydrate fraction may further be at least about 85% glucose and fructose.

In an embodiment, the carbohydrate fraction is at least 30% sugars, including glucose and/or fructose and/or other monosaccharide and/or other disaccharide and/or other oligosaccharide, and polyols. The carbohydrate fraction may also be about 50% sugars, including glucose and/or fructose and/or other monosaccharide and/or other disaccharide and/or other oligosaccharide, and polyols. The carbohydrate fraction may further be at least about 85% sugars, including glucose and/or fructose and/or other monosaccharide and/or other disaccharide and/or other oligosaccharide, and polyols.

In an embodiment, the carbohydrate fraction provides at least 50% of the energy of the nutritional composition, or at least 70% of the energy of the nutritional composition.

In an embodiment, the carbohydrate fraction includes dextrose and/or maltodextrins.

In an embodiment, the nutritional composition includes less than 40 g protein per 100 g nutritional composition.

In an embodiment, the nutritional composition includes less than 20 g fat per 100 g nutritional composition.

In an embodiment, the nutritional composition includes at least one vitamin selected from the group consisting of vitamin C, vitamin E, vitamin B12, niacin, vitamin B6, folic acid, biotin, panthotenic acid, vitamin B2, vitamin B6, or combinations thereof. The at least one vitamin may be present in an amount that is at least 10% of the recommended daily dose.

In an embodiment, the nutritional composition includes at least one electrolyte or mineral selected from the group consisting of sodium, potassium, calcium, iron, magnesium, zinc, or combinations thereof.

In an embodiment, the nutritional composition includes at least one amino acid selected from the group consisting of L-leucine, L-valine, L-isoleucine, or combinations thereof.

In an embodiment, the nutritional composition includes an energy density from about 800 kJ/100 g to about 2200 kJ/100 g.

In an embodiment, the nutritional composition includes at least one compound selected from the group consisting of aroma compounds, fiber, caffeine, guarana, acidifying agents, binding agents, gel building material, water, fruit juice, fruits, antioxidants, colorings agents, starch, cereals, protein powders, fats or combinations thereof.

In yet another embodiment, methods for making a packaged food product are provided. The methods include forming a solid nutritional composition comprising a carbohydrate fraction having glucose and fructose in a ratio from about 3:1 to about 1:1, depositing a coating of solid particles on at least one surface of the solid nutritional composition, and packaging the solid nutritional composition in a package.

In yet another embodiment, methods for making a packaged food product are provided. The methods include forming a solid nutritional composition comprising a carbohydrate fraction, depositing a coating of solid particles on at least one surface of the solid nutritional composition, and packaging the solid nutritional composition in a package.

In yet another embodiment, methods for making a packaged food product are provided. The methods include forming a solid nutritional composition comprising a carbohydrate fraction having glucose, depositing a coating of solid particles on at least one surface of the solid nutritional composition, and packaging the solid nutritional composition in a package.

In an embodiment, the solid nutritional composition is in the form of a bar. The forming may include cutting a nutritional composition into bars. The forming may further include cold extruding a nutritional composition. The forming may further include The forming may further include cold extruding a nutritional composition. The forming may further include other bar forming methods.

In an embodiment, the methods further include heating the solid nutritional compositions prior to depositing the solid particles thereon. The heating may be performed using infrared. The heating may be performed using microwave. The heating may be performed using conduction. The heating may be performed using convection. The heating may be performed using other heating methods as would be determined to be best for the condition.

In an embodiment, the methods further include rolling a roller over the at least one surface having solid particles to ensure adherence of the solid particles to the solid nutritional composition.

In an embodiment, the methods further include removing any excess solid particles from the nutritional composition with an air suction or blowing device.

In an embodiment, the methods further include removing any excess solid particles from the nutritional composition with shaking or vibration.

In an embodiment, the methods further include cooling the nutritional compositions before packaging.

In still yet another embodiment, methods for reducing the stickiness of a nutritional composition are provided. The methods include coating substantially all of at least one surface of a sticky nutritional composition with a plurality of solid particles selected from the group consisting of grains, rolled oats, cookie-type compositions, crisp discs, or combinations thereof.

In yet another embodiment, methods for improving the aesthetics of a solid nutritional composition are provided. The methods include coating substantially all of at least one surface of a nutritional composition with a plurality of solid particles selected from the group consisting of grains, rolled oats, cookie-type compositions, crisp discs, or combinations thereof.

In another embodiment, methods for improving the handling of a sticky nutritional composition are provided. The methods include coating substantially all of at least one surface of a sticky nutritional composition with a plurality of solid particles selected from the group consisting of grains, rolled oats, cookie-type compositions, crisp discs, or combinations thereof.

In an embodiment, the nutritional compositions include a carbohydrate fraction.

In an embodiment, the nutritional compositions include a carbohydrate fraction having glucose.

In an embodiment, the nutritional compositions include a carbohydrate fraction having glucose and fructose in a ratio from about 3:1 to 1:1.

An advantage of the present disclosure is to provide improved nutritional compositions.

Another advantage of the present disclosure is to provide nutritional compositions that are appealing to consumers.

Another advantage of the present disclosure is to provide nutritional compositions that provide a consumer with adequate carbohydrates for exercise.

Yet another advantage of the present disclosure is to provide nutritional compositions that are enjoyable and easy to consume.

Another advantage of the present disclosure is to provide solid nutritional compositions that are easily removed from packaging.

Yet another advantage of the present disclosure is to provide solid nutritional compositions that do not undesirably stick to the hands of the consumer.

Still yet another advantage of the present disclosure is to provide nutritional compositions that help to improve recovery from physical activity.

Another advantage of the present disclosure is to provide nutritional compositions that provide adequate nutrition for physical activity.

Yet another advantage of the present disclosure is to provide methods for making improved nutritional compositions.

Still yet another advantage of the present disclosure is to provide methods for providing an individual in need of same with adequate nutrition for physical activity.

Another advantage of the present disclosure is to provide methods for providing an individual in need of same with nutritional compositions to improve recovery from physical activity.

Another advantage of the present disclosure is to provide methods for providing an individual in need of same with nutritional compositions to improve recovery from physical activity.

Yet another advantage of the present disclosure is reducing the stickiness of a nutritional composition even in the presence of cold flow.

Additional features and advantages are described herein, and will be apparent from the following Detailed Description and the figures.

### BRIEF DESCRIPTION OF THE FIGURES

FIG. 1 illustrates a top view of a nutritional composition having solid particles on a surface thereof in accordance with an embodiment of the present disclosure.

FIG. 2 illustrates a cross-section of the nutritional composition of FIG. 1 along line 2-2, the nutritional composition having solid particles on a surface thereof in accordance with an embodiment of the present disclosure.

FIG. 3 illustrates a side view of a nutritional composition having solid particles on two surfaces in accordance with an embodiment of the present disclosure.

FIG. 4 illustrates a top view of a nutritional composition having solid particles on a surface thereof in accordance with an embodiment of the present disclosure.

### DETAILED DESCRIPTION

As used herein, “about” is understood to refer to numbers in a range of numerals. Moreover, all numerical ranges herein should be understood to include all integer, whole or fractions, within the range.

As used herein the term “amino acid” is understood to include one or more amino acids. The amino acid can be, for example, alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine, valine, or combinations thereof.

As used herein, the term “antioxidant” is understood to include any one or more of various substances such as beta-carotene (a vitamin A precursor), vitamin C, vitamin E, and selenium) that inhibit oxidation or reactions promoted by Reactive Oxygen Species (“ROS”) and other radical and non-radical species. Additionally, antioxidants are molecules capable of slowing or preventing the oxidation of other molecules. Non-limiting examples of antioxidants include astaxanthin, carotenoids, coenzyme Q10 (“CoQ10”), flavonoids, glutathione, Goji (wolfberry), hesperidin, lactowolfberry, lignan, lutein, lycopene, polyphenols, selenium, vitamin A, vitamin C, vitamin E, zeaxanthin, or combinations thereof.

While the terms “individual” and “patient” are often used herein to refer to a human, the invention is not so limited. Accordingly, the terms “individual” and “patient” refer to any animal, mammal or human having or at risk for a medical condition that can benefit from the treatment.

As used herein, sources of ω-3 fatty acids include, for example, fish oil, krill, plant sources of ω-3, flaxseed, walnut, and algae. Examples of ω-3 fatty acids include, for example, α-linolenic acid (“ALA”), docosahexaenoic acid (“DHA”), eicosapentaenoic acid (“EPA”), or combinations thereof.

As used herein, the term “minerals” is understood to include boron, calcium, chromium, copper, iodine, iron, magnesium, manganese, molybdenum, nickel, phosphorus, potassium, selenium, silicon, tin, vanadium, zinc, or combinations thereof.

“Nutritional products,” or “nutritional compositions,” as used herein, are understood to include any number of optional additional ingredients, including conventional food additives (synthetic or natural), for example one or more acidulants, additional thickeners, buffers or agents for pH adjustment, chelating agents, colorants, emulsifies, excipient, flavor agent, mineral, osmotic agents, a pharmaceutically acceptable carrier, preservatives, stabilizers, sugar, sweeteners, texturizers, and/or vitamins. The optional ingredients can be added in any suitable amount. The nutritional products or compositions may be a source of complete nutrition or may be a source of incomplete nutrition.

As used herein the term “patient” is understood to include an animal, especially a mammal, and more especially a human that is receiving or intended to receive treatment, as it is herein defined.

As used in this disclosure and the appended claims, the singular forms “a,” “an” and “the” include plural referents unless the context clearly dictates otherwise. Thus, for example, reference to “a polypeptide” includes a mixture of two or more polypeptides, and the like.

The terms “protein,” “peptide,” “oligopeptides” or “polypeptide,” as used herein, are understood to refer to any composition that includes, a single amino acids (monomers), two or more amino acids joined together by a peptide bond (dipeptide, tripeptide, or polypeptide), collagen, precursor, homolog, analog, mimetic, salt, prodrug, metabolite, or fragment thereof or combinations thereof. For the sake of clarity, the use of any of the above terms is interchangeable unless otherwise specified. It will be appreciated that polypeptides (or peptides or proteins or oligopeptides) often contain amino acids other than the 20 amino acids commonly referred to as the 20 naturally occurring amino acids, and that many amino acids, including the terminal amino acids, may be modified in a given polypeptide, either by natural processes such as glycosylation and other post-translational modifications, or by chemical modification techniques which are well known in the art. Among the known modifications which may be present in polypeptides of the present invention include, but are not limited to, acetylation, acylation, ADP-ribosylation, amidation, covalent attachment of a flavanoid or a heme moiety, covalent attachment of a polynucleotide or polynucleotide derivative, covalent attachment of a lipid or lipid derivative, covalent attachment of phosphatidylinositol, cross-linking, cyclization, disulfide bond formation, demethylation, formation of covalent cross-links, formation of cystine, formation of pyroglutamate, formylation, gamma-carboxylation, glycation, glycosylation, glycosylphosphatidyl inositol (“GPI”) membrane anchor formation, hydroxylation, iodination, methylation, myristoylation, oxidation, proteolytic processing, phosphorylation, prenylation, racemization, selenoylation, sulfation, transfer-RNA mediated addition of amino acids to polypeptides such as arginylation, and ubiquitination. The term “protein” also includes “artificial proteins” which refers to linear or non-linear polypeptides, consisting of alternating repeats of a peptide.

Non-limiting examples of proteins include dairy based proteins, plant based proteins, animal based proteins and artificial proteins. Dairy based proteins may be selected from the group consisting of casein, caseinates, casein hydrolysate, whey, whey hydrolysates, whey concentrates, whey isolates, milk protein concentrate, milk protein isolate, or combinations thereof. Plant based proteins include, for example, soy protein (e.g., all forms including concentrate and isolate), pea protein (e.g., all forms including concentrate and isolate), canola protein (e.g., all forms including concentrate and isolate), other plant proteins that commercially are wheat and fractionated wheat proteins, corn and it fractions including zein, rice, oat, potato, peanut, and any proteins derived from beans, buckwheat, lentils, pulses, single cell proteins, or combinations thereof. Animal based proteins may be selected from the group consisting of beef, poultry, fish, lamb, seafood, or combinations thereof.

All dosage ranges contained within this application are intended to include all numbers, whole or fractions, contained within said range.

As used herein, the terms “treatment,” “treat” and “to alleviate” include both prophylactic or preventive treatment (that prevent and/or slow the development of a targeted pathologic condition or disorder) and curative, therapeutic or disease-modifying treatment, including therapeutic measures that cure, slow down, lessen symptoms of, and/or halt progression of a diagnosed pathologic condition or disorder; and treatment of patients at risk of contracting a disease or suspected to have contracted a disease, as well as patients who are ill or have been diagnosed as suffering from a disease or medical condition. The term does not necessarily imply that a subject is treated until total recovery. The terms “treatment” and “treat” also refer to the maintenance and/or promotion of health in an individual not suffering from a disease but who may be susceptible to the development of an unhealthy condition, such as nitrogen imbalance or muscle loss. The terms “treatment,” “treat” and “to alleviate” are also intended to include the potentiation or otherwise enhancement of one or more primary prophylactic or therapeutic measure. The terms “treatment,” “treat” and “to alleviate” are further intended to include the dietary management of a disease or condition or the dietary management for prophylaxis or prevention a disease or condition.

As used herein the term “vitamin” is understood to include any of various fat-soluble or water-soluble organic substances (non-limiting examples include vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, K1 and K2 (i.e. MK-4, MK-7), folic acid and biotin) essential in minute amounts for normal growth and activity of the body and obtained naturally from plant and animal foods or synthetically made, pro-vitamins, derivatives, analogs.

The present nutritional compositions are directed to solid nutritional compositions that are designed to provide adequate nutrition for performance, to be aesthetically desirable to the consumer, and to be easily removed from its wrapping for consumption. Power and/or performance bars are known in the art and are typically consumed by individuals requiring increased carbohydrate loads for improved or sustained athletic performance or increased mental alertness. These types of known performance bars, however, may suffer from certain limitations or pitfalls in the eyes of consumers.

Indeed, although the performance bars provide individuals with adequate nutrition for prolonged or endurance performance, the individual may not enjoy consuming these types of performance bars. For example, known performance bars may be heavy or dense or have a chalky or bland taste. Additionally, known performance bars may also be formulated such that the solid bars are sticky to handle and, as a result, difficult to remove from its wrapper for consumption. As a result, a portion of the wrapper may stick to the bar and leave a remnant attached thereto. Further, the consumer may experience sticky hands in attempting to remove the portion of the wrapper stuck to the bar, or even in attempting to unwrap the bar for consumption. Additionally, the consumer may need two hands to unwrap the composition, which may be a problem in some sports (e.g. biking).

There have been several approaches to solving the problem of stickiness with performance bars. For example, chocolate coatings have previously been applied to the exterior surface of performance bars. This method is undesirable, however, because when the bars exhibit cold-flow (e.g., deformation at ambient temperature), the chocolate coating typically breaks, which negatively affects the product's appearance. Rice paper has also been applied to performance bars to reduce their stickiness. However, when the performance bars exhibit cold-flow, there is typically a separation between the product and the rice paper, which is undesirable. Other methods for dealing with the stickiness of performance bars include powder coatings and oil coatings. However, powder coatings of, for example, starch-based powders, generally provide an unappealing product appearance to the consumer. Similarly, oil-based coatings can leave a greasy, undesirable product appearance, and the oil may be absorbed by the product during its shelf life, which suppresses the sticky-reducing effects of the oil.

In contrast, the nutritional compositions of the present disclosure provide athletes very efficiently with carbohydrates and/or other sticky composition, and an increased rate of exogenous carbohydrate oxidation before or during exercise, while at the same time being enjoyable and easy to consume. In this manner, the solid nutritional compositions of the present disclosure include a coating of solid particles that are used to at least partially cover the surface of the sticky nutritional composition and create a physical barrier between the product surface and its packaging, or the hands of the consumer. Also, upon cold flow, the product appearance is not affected when using solid particles as opposed to e.g. rice paper or chocolate coating.

While the nutritional compositions of the present disclosure are disclosed as being useful for consumption by athletes, it is, however, clear, that the nutritional compositions of the present disclosure can be used by anybody in need of carbohydrate supply. For example, the nutritional compositions of the present disclosure can be very well used as transportable food for people, who do not wish to carry too heavy provisions, for example during long term trips (including sport rallies, astronauts, soldiers). The nutritional compositions of the present disclosure may equally well be used by people to provide the body with carbohydrates for example before or during an examination in school or at the university.

Similarly, while the nutritional compositions of the present disclosure are disclosed as being for performance and supplying a carbohydrate load, it is clear that the nutritional compositions of the present disclosure may also be any nutritional composition that has a sticky outer surface.

In an embodiment, nutritional compositions of the present disclosure are directed to solid nutritional compositions having a coating of solid particles on an outer surface. The solid particles may be any edible solid particles capable of coating the surface of a solid nutritional composition, but not detracting from the taste or aesthetics of the composition. For example, the solid particles may be oats or other grains, cookie-type compositions, crisp discs, or any combination thereof. In an embodiment, the solid particles are crisp discs. In another embodiment, the solid particles are rolled oats.

The solid particles may be flat or three-dimensional, so long as the particles are capable of coating a surface of the solid nutritional composition. Similarly, the solid particles may have any shape known in the art including, for example, oval, circular, triangular, square, rectangular, pentagonal, hexagonal, heptagonal, octagonal, etc. In an embodiment, however, the solid particles are flat, circular or oval discs that coat a surface of a solid nutritional composition.

Further, the solid particles may be artificially or naturally colored to provide improved aesthetics to the nutritional compositions. For example, the solid particles may have any color known in the art including, but not limited to white, black, red, orange, yellow, green blue, purple, pink, or any combinations thereof. In this manner, a nutritional composition may be coated with solid particles having one color, or may be coated with solid particles of several different colors. By providing a nutritional composition that is coated with several different colors, the nutritional compositions is more aesthetically appealing to the consumer.

The solid particles should have a rather small size so that a surface of a nutritional composition may be coated by many solid particles. For example, the solid particles may have a diameter that is between about 1 and 10 mm. In another embodiment, the solid particles have a diameter that is between about 2 and 8 mm. In an embodiment, the solid particles have a diameter that is between about 2 and 6 mm. In yet another embodiment, the solid particles have a diameter of about 4 mm. The height of the solid particles is also very small and should be less than about 2 mm. In an embodiment, the height of the solid particles is less than about 1 mm. In an embodiment, the height of the solid particles is about 0.5 mm.

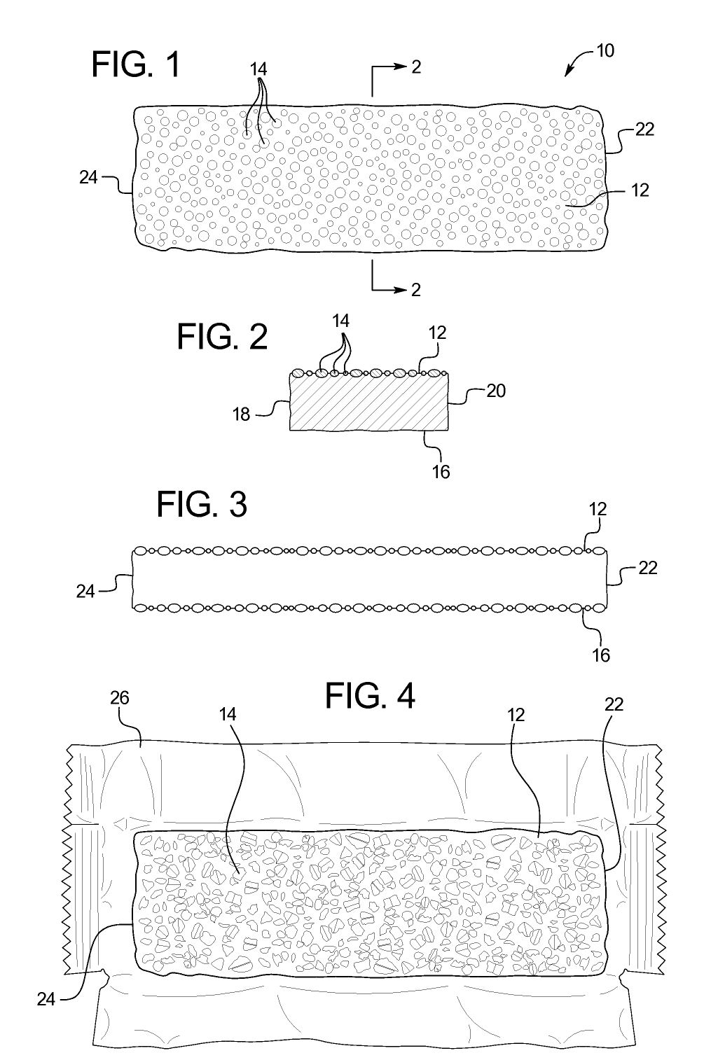

FIG. 1 illustrates a nutritional composition 10 in accordance with the present disclosure. Nutritional composition 10 includes a top surface 12 having a coating of solid particles 14 thereon. As shown by FIG. 2, nutritional composition 10 includes a bottom surface 16, which does not include a coating of solid particles. The skilled artisan will appreciate, however, that bottom surface 16 may also include a coating of solid particles 14, as is shown in FIG. 3. In this manner, nutritional compositions 10 of the present disclosure may be coated with solid particles 14 on top side 12, bottom side 16, either or both of sides 18, 20, or any combination thereof. Additionally, the nutritional compositions of the present disclosure may also include a coating of solid particles 14 on either or both ends 22, 24.

Although the solid particles in FIGS. 1-3 are illustrated as being crisp discs, the skilled artisan will appreciate that any solid particles described above may be used. For example, FIG. 4 illustrates an embodiment wherein the solid particles 14 are rolled oats instead of crisp discs. Both rolled oats or crisp discs, however, will reduce the surface stickiness of nutritional composition 10, helping to prevent it from sticking to its wrapper 26 or the hands of consumers. Although illustrated as a foil wrapper 26, nutritional compositions 10 may be any packaging known in the art for containing nutritional compositions. The packaging may be manufactured from a material selected from the group consisting of cardboard, plastic, metal, foil, or combinations thereof. For example, the packaging may be a foil wrapper, a plastic wrapper, a cardboard container, a metal container, or any combinations thereof, or any other suitable packaging.

As used herein, “crisp discs” refer to very flat, small, solid particles having a composition that is high in carbohydrates and low in fats. The crisp discs may be a cookie-type product and can be made from ingredients such as, for example, wheat flour, sugar, fat powder, cocoa powder, natural vanilla flavor, salt and a raising agent such as sodium bicarbonate. The crisp discs are generally known in the art as an extruded cereal product, produced by high pressure cooker extrusion and finished by air drying to the required moisture levels. In an embodiment, the solid particles are crisp discs that are very flat and have a height that is less than 1 mm. In this embodiment, the crisp discs are rather small and have a diameter that is less than 4 mm.

Regardless of the composition of the solid particles, however, the particles should have a rough surface that allows them to remain at the surface of the solid nutritional composition. Other solid particles tested by Applicant did not adhere properly to the nutritional compositions because they had a smooth surface, an oily surface, or were not flat enough. Examples of the other solid particles tested by Applicant include, for example, seeds or granulated nuts.

In an embodiment wherein the nutritional compositions are carbohydrate bars, the nutritional compositions will typically include beneficial ingredients such as, for example, energy-rich cereals and fresh fruit. Further, Applicant believes that an intake of even 90 grams of carbohydrate (“CHO”) per hour in the form of a nutritional composition, as well as 30-60 g CHO/h as recommended by the American College of Sports Medicine, is well tolerable if ingested as carbohydrate mixture comprising glucose and fructose in a ratio in the range of 3:1 to 1:1, or more specifically 2:1. Additionally, the gastric tolerance of a liquid nutritional composition delivering a mixture of glucose and fructose at relatively high rates during a real life situation of either running or cycling outdoors.

Applicant further believes that the ingestion of 90 grams/h of the above carbohydrate mixture will allow to keep the distress of the GI-tract of athletes minimal, and at about a rate of 15% of subjects. Furthermore, it is believed that the minimal GI distress will not increase as compared with an intake of 60 grams of a carbohydrate mixture comprising glucose and fructose in a ratio in the range of 3:1 to 1:1, preferably 2:1 per hour.

Consequently, one embodiment of the present disclosure is a nutritional composition comprising a carbohydrate fraction. In another embodiment of the present disclosure is a nutritional composition comprising a carbohydrate fraction comprising glucose. In another embodiment of the present disclosure is a nutritional composition comprising a carbohydrate fraction comprising glucose and fructose in a ratio in the range of 3:1 to 1:1. The nutritional compositions of the present disclosure are food products may be solid carbohydrate bars that include at least one carbohydrate source, and preferably a multiple carbohydrate source such as the combination of glucose and fructose, or maltodextrin and fructose. The shape of the bar is not essential, it does not have to be rectangular, it may equally have other shapes, for example, round or triangular. The nutritional compositions of the present disclosure may contain less than 30%, or less than 20%, or even less than 10% moisture. In an embodiment, the nutritional compositions include less than 8% moisture.

The nutritional compositions may contain a grain or grains, nuts, possibly dried fruit, fruit paste, sweeteners, bulking agents such as polyols and other ingredients. These ingredients can be mixed with a binder such as a sugar syrup or shortening and compressed into bars or slabs which may be later cut to a desired size. Depending on the bar's composition, it may be mixed, formed, extruded, enrobed and/or baked prior to packaging and sale. The nutritional composition may also be a dried food product, or may include a crust or a filling.

For achieving good results in compressed foods, glycerin and/or other polyhydric alcohols may be added to the nutritional compositions to yield better mold release and bonding strength of the overall nutritional composition.

The multiple carbohydrate source may contain fructose and glucose in a digestible form. Glucose and/or fructose may be provided in the form of fructogenic and/or glucogenic carbohydrates. Fructogenic carbohydrates are carbohydrates which upon theoretical total hydrolysis release at least one fructose molecule. Glucogenic carbohydrates are carbohydrates which upon theoretical total hydrolysis release at least one glucose molecule. Consequently, a carbohydrate can be both, glucogenic and fructogenic (e.g., saccharose). For example in performance bars, glucogenic sources may be also extruded cereal pieces, cereal flakes, flours and starches.

Hence, the carbohydrates may comprise or consist of monosaccharides, such as glucose or fructose as basic carbohydrate units. The monosaccharides may represent a part of disaccharides, such as sucrose, lactose, maltose or cellobiose. The monosaccharides such as glucose or fructose may also represent a part of oligosaccharides or polysaccharides. Preferred carbohydrate sources for the present invention are maltodextrins and/or dextrose. The carbohydrate source may additionally comprise indigestible carbohydrates, in particular fibers.

The carbohydrate fraction of the nutritional compositions may comprise at least 30% glucose and fructose, preferably at least 50% glucose and fructose more preferably at least 85% glucose and fructose. In one embodiment of the present disclosure the carbohydrate fraction of the nutritional compositions provides at least 50%, preferably at least 70% of the energy of the nutritional composition.

The nutritional compositions of the present disclosure include a carbohydrate fraction and, optionally, a protein fraction and/or a fat fraction.

The presence of proteins and/or fats in the nutritional compositions of the present disclosure has the advantage that this way it is possible to provide the athlete with a more complete nutrition during performance. Furthermore, the presence of proteins allows producing a nutritional composition with a modified taste.

As a protein source, any suitable dietary protein may be used, for example animal proteins (such as milk proteins, meat proteins and egg proteins); vegetable proteins (such as soy protein, wheat protein, rice protein, and pea protein); mixtures of free amino acids; or combinations thereof. In an embodiment, milk proteins such as casein and whey, and soy proteins are included in the nutritional compositions.

The proteins may be intact or hydrolyzed or a mixture of intact and hydrolyzed proteins. It may be desirable to supply partially hydrolyzed proteins (degree of hydrolysis between 2 and 20%), for example for athletes believed to be at risk of developing cows' milk allergy. Additionally, in generally at least partially hydrolyzed proteins may be easier and faster to metabolize by the body. This is in particular true for amino acids. Consequently, it is further preferred that the nutritional compositions of the present disclosure contain single amino acids. In an embodiment, however, essential amino acids are included in the nutritional compositions. In one embodiment the nutritional compositions of the present disclosure contain amino acids such as L-leucine, L-valine and/or L-isoleucine.

If the compositions include a fat source, the fat source has the advantage that, for example, an improved mouth feel can be achieved. Any fat source is suitable. For example, animal or plant fats may be used. To increase the nutritional value, ω-3-unsaturated and ω-3-unsaturated fatty acids may be comprised by the fat source. The fat source may also contain long chain fatty acids and/or medium chain fatty acids. For example, milk fat, canola oil, almond butter, peanut butter, corn oil and/or high-oleic acid sunflower oil may be used.

Preferably, the nutritional compositions contain less than 40 g protein per 100 g nutritional composition and/or less than 20 g fat per 100 g nutritional composition.

The nutritional compositions may also contain minerals and micronutrients such as trace elements and vitamins in accordance with the recommendations of Government bodies such as the United States Recommended Daily Allowances (“USRDA”).

The nutritional compositions may contain vitamins, such as Vitamin C, Vitamin E, Vitamin B12, Niacin, Vitamin B6, folic acid, biotin, panthotenic acid, Vitamin B2 and/or Vitamin B6, preferably in amounts that correspond to at least 10% of the recommended daily dose. The presence of vitamins may contribute to the effectiveness of the nutritional composition and may further protect the athlete. For example, the presence of vitamin C will help to protect against catching a common cold. The nutritional compositions may also include electrolytes and/or minerals, such as sodium, potassium, calcium, iron, magnesium or zinc.

These nutritional compounds may be helpful to replenish the body with compounds that the person is constantly loosing due to the generation of sweat during exercise. They may also help to prevent the generation of post-exercise sore muscles.

The nutritional compositions of the present disclosure may further contain one or more compounds selected from the group consisting of aroma compounds, fiber, caffeine, guarana, acidifying agents, binding agents, gel building material, water, fruit juice, fruits, antioxidants, and coloring agents, or combinations thereof.

These agents may improve the nutritional compositions of the present disclosure with respect to many properties, such as taste, consistency, color, and stability during storage, digestibility, and many more that are known to those of skill in the art.

The energy density of the nutritional compositions is not critical for effectiveness. However, a high energy density has the advantage that less food needs to be ingested to replenish carbohydrates as fuel to the body. Consequently, high energy densities are preferred for the nutritional compositions of the present disclosure.

In an embodiment of the present disclosure, the nutritional compositions have an energy density of about 800 to about 2200 kJ/100 g, or more specifically about 1000 to about 2000 kJ/100 g. In an embodiment, the nutritional compositions have an energy density of about 1200 to about 1800 kJ/100 g.

Alternatively, the bar of the present disclosure may also be provided as bite size bars with a serving size between 3 and 15 g. In an embodiment, a serving size of the bite size bars is between 5 and 10 g. In this manner, the carbohydrate uptake can be precisely adjusted to the needs of, for example, an athlete.

A typical nutritional composition of the present disclosure may comprise the following percentages of daily values (“DV”) based on a 2000 calorie diet: between 4 and 6% total fat, including between 1 and 3% saturated fats, between 5 and 9% sodium, between 0.5 and 1.5% potassium, between 12 and 16% carbohydrates, including between 5 and 10% glucose and fructose, and between 10 and 14% proteins.

Additionally it may comprise between 80 and 120% DV vitamin C, between 20 and 30% DV calcium, between 25 and 35% DV iron, between 80 and 120% DV vitamin E, between 80 and 120% DV thiamin, between 80 and 120% DV riboflavin, between 80 and 120% DV niacin, between 80 and 120% DV vitamin B6, between 80 and 120% DV folate, between 80 and 120% DV vitamin B12, between 80 and 120% DV biotin, between 80 and 120% DV pantothenic acid, between 20 and 30% DV phosphorus, between 20 and 30% DV magnesium, between 25 and 35% DV zinc, between 25 and 35% copper, and between 15 and 25% DV chromium.

The nutritional composition of the present disclosure may be used, for example, as a food product, as a food additive or as a nutraceutical.

In an embodiment of the present disclosure the nutritional compositions of the present disclosure are used for the preparation of a food product or as a food product to provide an increased performance, in particular endurance performance.

For exercise in general, but in particular for competitive exercise it is essential that the body has blood sugar available for the muscles to burn at all times. In particular at the end of a race it must be avoided, or the athlete will run out of energy. The subject matter of the present disclosure is well suited to prevent this. According to one embodiment of the present disclosure, the nutritional compositions of the present disclosure can be used to allow for an enhanced blood sugar maintenance late in exercise.

The present nutritional compositions cannot only secure a long lasting blood sugar maintenance, it can also be used to provide an increased exogenous carbohydrate oxidation. Increasing exogenous carbohydrate oxidation was found to be in particular increased if the carbohydrate uptake of a person is greater than 1 g/min, preferably greater than 1.1 g/min even more preferred greater than 1.2 g/min.

Consequently, surprisingly, optimal exogenous carbohydrate oxidation is reached at a carbohydrate ingestion above the theoretical threshold once thought for carbohydrate oxidation. See, Jeukendrup A E and Jentjens R., Sports Med 29: 407-424 (2000). This way, the energy delivery from carbohydrates during physical exercise can be maximized.

Further, the present nutritional compositions may be used to provide faster energy delivery, in particular to working muscles, and/or to provide more sustained energy to muscles. Both effects will contribute to an optimal performance of an athlete.

The present nutritional compositions may also be used to treat or prevent symptoms of fatigue and/or to improve cycling cadence, for example measured in revolutions per minute and/or to decrease ratings of perceived exertion (“RPE”).

Applicant has found that the above listed uses can be successfully carried out with any amounts of carbohydrates comprising glucose and fructose in a ratio of 3:1 to 1:1 to be ingested. However, Applicant believes that best results may be obtained, when the nutritional compositions are used in an amount that corresponds to an ingestion of at least 30 g CHO/h, preferably at least 50 g CHO/h, more preferably at least 65 g CHO/h and most preferably between 80 g CHO/h and 110 g CHO/h.

The higher the amount of carbohydrates ingested per hour is, the more the exogenous carbohydrate oxidation can be increased. Applicant believes that a maximum of exogenous carbohydrate oxidation will be reached when the nutritional compositions are consumed so that 100 g-150 g carbohydrates are consumed per hour, preferably 110 g-130 g carbohydrates per hour and most preferred 115 g-125 g carbohydrates per hour.

The nutritional compositions of the present disclosure may be manufactured by any process suitable for forming solid nutritional compositions. For example, in a first process, the nutritional compositions may be formed and cut as bars according to known processing techniques. The bars may then be briefly heated to melt the surfaces to increase their stickiness. The heating may be performed by any known heating techniques. In an embodiment, however, the bars are heated using infrared heating. Solid particles may then be sprinkled on a top surface of the bars and/or bottom-coated on a bottom surface of the bars. To ensure adherence of the solid particles to the bars, a roller may be used to apply light pressure to the bars. Excess solid particles can be removed from the bars using methods such as air suction or blowing devices, vibrations, or shaking. In one embodiment, the bars are then cooled before packaging.

In a second process for manufacturing the nutritional compositions of the present disclosure, the nutritional compositions are cold extruded. In this process, the solid particles may be sprinkled on a top surface of the bars and/or bottom-coated on a bottom surface of the bars at the beginning of the process line. Again, a roller may be used to apply light compression to the bars to ensure adherence of the solid particles. Excess solid particles can be removed from the bars using air suction or blowing devices, vibrations, or shaking. In one embodiment, the bars are then cooled before packaging.

After being cooled, if necessary, and packaged, the nutritional compositions may be packaged in containers to be shipped to retail stores and placed on shelves for sale to consumers. During the shelf life of the product, the solid particles may absorb some humidity from the nutritional compositions, but this does not affect adhesiveness of the solid particles to the solid nutritional compositions. Furthermore, cold flow may occur during shelf life, but particles remain at the bar surface keeping good effectiveness with time.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A packaged food product comprising a package housing and a nutritional composition having reduced stickiness on its surface, comprising a plurality of solid particles on at least one surface of the nutritional composition and a carbohydrate, wherein the solid particles have a diameter between about 1 mm and about 10 mm, and wherein the at least one surface of the nutritional composition is an external surface.

2. The packaged food product according to claim 1, wherein the carbohydrate is glucose, fructose or glucose and fructose.

3. The packaged food product according to claim 1 or claim 2, wherein the solid particles are selected from a group consisting of rolled oats, grains, cookie particles, crisp discs, and any combinations thereof.

4. The packaged food product according to any one of claims 1 to 3, wherein the solid particles are artificially colored.

5. The packaged food product according to claim 4, wherein the solid particles are comprise at least two different colors.

6. The packaged food product according to any one of claims 1 to 3, wherein the solid particles further comprise at least one natural coloring agent.

7. The packaged food product according to claim 6, wherein the solid particles are comprise at least two different colors.

8. The packaged food product according to any one of claims 1 to 7, wherein the solid particles have a rough surface.

9. The packaged food product according to any one of claims 1 to 8, wherein the solid particles have a high sugar content and low amounts of fats and proteins.

10. The packaged food product according to any one of claims 1 to 8, wherein the solid particles have a high protein and a high sugar content.

11. The packaged food product according to any one of claims 1 to 10, wherein the solid particles have a shape selected from the group consisting of oval, circular, triangular, square, rectangular, pentagonal, hexagonal, heptagonal, octagonal, and combinations thereof.

12. The packaged food product according to any one of claims 1 to 11, wherein the carbohydrate fraction comprises at least 30% glucose and/or fructose.

13. The packaged food product according to claim 1, wherein the carbohydrate fraction comprises dextrose, maltodextrins, polyols monosacchharides, disacchharides, or oligosaccharides or combinations thereof.

14. The packaged food product according to any one of claims 1 to 13, wherein the nutritional composition further comprises:
at least one vitamin selected from the group consisting of vitamin C, vitamin E, vitamin B12, niacin, vitamin B6, folic acid, biotin, panthotenic acid, vitamin B2, vitamin B6, and combinations thereof;
at least one electrolyte or mineral selected from the group consisting of sodium, potassium, calcium, iron, magnesium, zinc, and combinations thereof;
at least one compound selected from the group consisting of aroma compounds, fiber, caffeine, guarana, acidifying agents, binding agents, gel building material, water, fruit juice, fruit, antioxidants, colorings agents, and combinations thereof;
at least one amino acid selected from the group consisting of L-leucine, L-valine, L-isoleucine, and combinations thereof; and
combinations thereof.

15. The packaged food product according to any one of claims 1 to 14, wherein the package is manufactured from a material selected from the group consisting of paperboard, cardboard, plastic, metal, foil and combinations thereof.

16. A method for making a packaged food product having reduced stickiness on at least one external surface, the method comprising the steps of:
forming a solid nutritional composition comprising a carbohydrate fraction;
depositing a coating of solid particles on at least one surface of the solid nutritional composition; and
packaging the solid nutritional composition in a package.

17. The method according to claim 16, wherein the solid nutritional composition is in the form of a bar or wherein the forming includes cutting a nutritional composition into bars.

18. The method according to claim 16 or 17, wherein the forming further includes cold extruding a nutritional composition.

19. The method according to any one of claims 16 to 18, further comprising at least one of the steps of:
heating the solid nutritional compositions prior to depositing the solid particles thereon;
rolling a roller over the at least one surface having solid particles to ensure adherence of the solid particles to the solid nutritional composition;
removing any excess solid particles from the nutritional composition;
cooling the nutritional compositions before packaging; or
combinations thereof.

20. The method according to any one of claims 16 to 19, wherein the package is manufactured from a material selected from the group consisting of paperboard, cardboard, plastic, metal, foil and combinations thereof.

21. The method according to any one of claims 16 to 20, wherein the solid nutritional composition is selected from a group consisting of those claimed in claim 1 to claim 15.
